(19) United States
(12) Patent Application Publication
(10) Pub. No.: US 2007/0126579 A1
(43) Pub. Date: Jun. 7, 2007

(54) Passive radio frequency identification (RFID) transponder/reader system and method for survey marker location

(76) Inventors: David Rodney Adams, Austin, TX (US); Donna Lynn Fedukowski, Bandon, OR (US)

Correspondence Address: DAVID ADAMS, 10210 MATOCA WAY, AUSTIN, TX, 78726, US

(21) Appl. No.: 11/292,959

(22) Filed: Dec. 2, 2005

(51) Int. Cl. G08B 13/14; G08B 1/08; G08B 5/22; G01S 1/00; G01S 3/02

(52) U.S. Cl. 340/572.1; 340/825.49; 340/539.13; 340/539.32; 342/385; 342/450

(57) ABSTRACT

A system designed to identify survey markers that are obscured by an accumulation of dust and dirt or overgrowth of vegetation. The system provides for automatic detection of survey markers using passive radio frequency transponder technology to detect the immediate presence of a tagged survey marker and read additional unique identification data corresponding to said marker. The operator can be signaled audibly and/or visually when a tagged survey marker is detected. The transmitter and antennae are mounted in a handheld or portable unit. An integrated microprocessor performs the requisite algorithms needed to process the reply from one or more RFID (Radio Frequency Identification) tags and generate the alert signals for the operator alerts. Once the RFID tagged survey marker has been located, it can be cleared of accumulated dust, dirt and overgrowth of vegetation to make it visible for confirming the property boundary. Handheld RFID programmers are used to load or record important identification data in the attached tag, regarding latitude-longitude location, and other pertinent survey data.

### 1. BACKGROUND OF THE INVENTION

1.1—Field of the Invention

The present invention relates generally to systems for the detection and location of hidden survey markers and, more particularly, to a RFID transponder/ reader system for the detection and location of transponder-tagged survey markers during re-surveying operations and for the storage and transmission of information related to the transponder-tagged survey marker.

1.2—Description of the Prior Art

Property boundary lines often run through poorly accessible remote areas. These boundary lines generally must be re-discovered by survey prior to building fences or other improvements to the property, or transferring ownership of the property. While survey markers on small urban lots are relatively easy to locate, larger pieces of property usually present a challenging and time consuming effort to locate existing survey markers, especially if they are buried or obscured by overgrowth of vegetation. The best buried survey markers available are magnetic. Magnetic markers may be detectable from a range of up to 3 meters with quality metal detectors used by professional survey teams. In actual experience, some survey markers cannot be located, even with professional equipment. Thus, a need exists for a more effective system for tagging and re-locating property boundary survey markers.

### 2. BRIEF SUMMARY OF THE INVENTION

2.1—The present invention is directed to a system of transponder tags/reader for survey marker detection and location.

2.2—Preferably, the present invention uses passive RFID transponder tags with a reader for the detection and location of survey markers.

2.3—The present invention is further directed to a system of survey marker identification to provide detailed information pertaining to the tagged survey marker.

2.4—The present invention is further directed to a method for the detection and location of survey markers.

2.5—Thus, the present invention provides a system of transponder tags/reader for survey marker detection and location.

2.6—The present invention is defined to be substantially compatible with prior RFID technology, in order to minimize costs of implementation, with differentiation applied as necessary to achieve system utility defined above.

2.7—These and other aspects of the present invention will become apparent to those skilled in the art after a reading of the following description of the preferred embodiment when considered with the drawings.

### 3. OBJECTS OF THE INVENTION

3.1—The invention provides a system, whereby property boundary survey markers may be more readily identified and located after an original property survey.

3.2—The invention creates a system of property boundary survey markers that respond to radio frequency interrogation and respond with unique identifying information, preferably including specific location coordinates.

### 4. ADVANTAGES OF THE INVENTION

4.1—The present invention provides a system, whereby property boundary survey markers may be more efficiently and cost effectively identified and located (compared to prior art) after an original property survey.

4.2—The present invention has potential to become an integral part of required standard survey and mapping infrastructure regulation in the United States and eventually worldwide.

### 5. LIST OF DRAWINGS-FIGURES

FIG. 1—Block diagram view of system

FIG. 2—Block diagram view of controller

### 6. DRAWINGS-LIST OF REFERENCE NUMBERS

10—The entire transponder/detection system
20—Transponder
30—Discontinuous radio frequency communication
40—Portable RF transponder detection system
50—RF interrogator
60—Antenna
70—Controller
72—User interface
74—Power switch/power indicator
76—Visual alarm
78—Display screen
80—Microcontroller
82—Audible alarm
84—Test switch
86—Reset switch

### 7. BRIEF DESCRIPTION OF THE SEVERAL VIEWS OF THE DRAWINGS

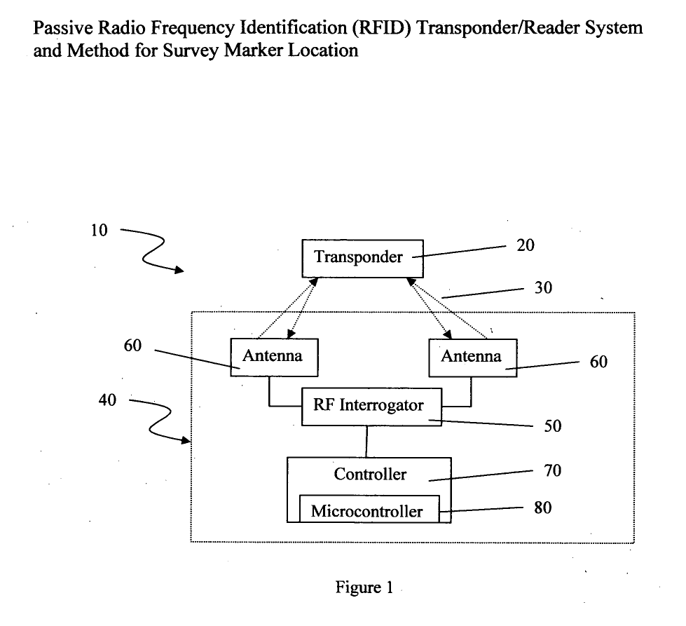

FIG. 1 is a diagrammatic view of a transponder/reader system for the detection of survey markers constructed according to the present invention.

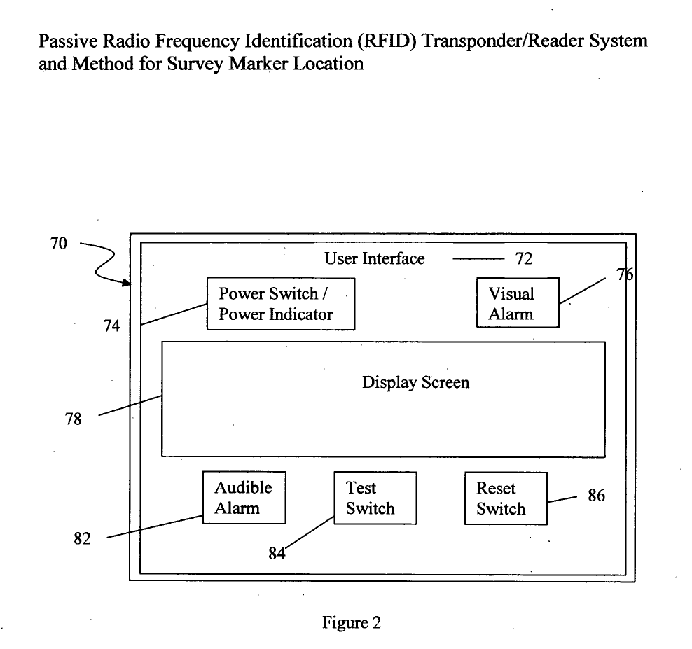

FIG. 2 is a detailed view of the user interface according to an embodiment of the present invention.

### 8. DETAILED DESCRIPTION OF THE INVENTION

8.1—In the following description, like reference characters designate like or corresponding parts throughout the several views. Also in the following description, it is to be understood that such terms as “forward,” “front,” “back,” “right,” “left,” and the like are words of convenience and are not to be construed as limiting terms.

8.2—Referring to the drawings in general, the illustrations are for the purpose of describing a preferred embodiment of the invention and are not intended to limit the invention thereto. As best seen in FIG. 1, the detector system, generally described as 10, includes a transponder 20, in discontinuous radio frequency communication 30 with a portable RF transponder detection system, generally described as 40. The portable RF transponder detection system is composed of an RF interrogator 50 connected to at least one antenna 60 and the controller 70, which contains the microcontroller 80.

8.3—More particularly, the transponder 20 is preferably a passive Radio Frequency Identification (RFID) transponder. A passive transponder requires no battery and contains integrated non-volatile memory that allows data to be written to and read from individual tags. The transponder tag can be programmed with any type of data desired within the size constraint of the memory. This programming may be done in the field at installation or prior to installation. However, it is not necessary to have any user programming performed for the system to work, as each transponder is factory programmed with a unique identification (ID) number, which is all that is needed for positive detection and identification. Thus, the transponder may be of a type that only transmits a signal to indicate presence, or of a type that can output other information, such as a unique identifier, specific location, a description of the tagged survey marker, and the like. The location information may be the location based on geographic coordinates or relative location, such as the relationship of the particular RFID to local buried survey markers. The description of the tagged survey marker may include the date of original survey, the name and license number of the surveyor, the name of the landowner, and other information.

8.4—In the preferred embodiment or best mode, the type of data stored in the tag is virtually unlimited. The current technology for the 915 MHz tags allows for a total storage capacity of 1024 bits of which 880 are available for use in the application. That space would hold approximately 145 ASCII characters uncompressed. Numeric data is capable of being stored in binary form. It is expected that the memory capacity will increase as the technology matures; as such the scope of the present invention is intended to include such memory capacity increases. The remaining memory in this embodiment, 144 bits, is reserved for tag identification and format information. A unique 64-bit ID number is assigned to each tag made, another 32 bits are reserved for a manufacturer/tag type code and the last 48 bits are reserved for tag memory layout which can be different for each type of application. The following list is representative of the type of data that can be useful in this application. The formatting and memory allotment following some of the types of data are to demonstrate how the available 880 bits could be used. Examples of data that can be stored include: Survey marker Types (8-bit reference code supports 256 types), Property Owner (136 bits), Survey Company Name (96 bits), Emergency Phone Number (40 bits), Surveyor License Number (32 bits), Location (degrees—48 bits), Latitude (24 bits), Longitude (24 bits), Install Date (16 bits), Absolute days since Jan. 1, 1900, Last Service Date (16 bits), Absolute days since Jan. 1, 1900, Local References Count (4 bits), References variable list of up to 15 nearby reference points, Local Reference (40 bits), Distance to next survey marker (16 bits—centimeters (655 meters max), Direction to next survey marker—16 bits—degrees, Survey marker type code—8 bits. Any additional data could be easily stored in a database indexed to the tag ID number—each of which is unique in the world.

8.5—The RF transponder detection system interrogates the surrounding area for RFID tags several times per second. The equipment should be designed to reliably record a target at a range of at least 5 meters, preferably 10 meters. This capability, supplemented by Wide Area Augmentation System enabled Global Positioning System (WAAS-enabled GPS) location data should be sufficient to enable successful location of tagged survey markers.

8.6—Conditions that may adversely affect the detection range of the system include the following: vegetation density, type of plant or vegetation, signal polarization, contact surfaces, and shielding. The higher the vegetation density between RFID tag and the reader the more the signal will be attenuated. The type of plant and the size of the leaves can make noticeable differences in the detection range. Preferably, the following considerations are recommended to ensure proper functioning of the system according to the present invention.

8.6.1—Polarization—RFID tags and reader antenna should be oriented correctly. Also, other antenna techniques such as circular polarization could be employed if required.

8.6.2—Contact surfaces—RFID tags cannot be placed directly against metal.

8.6.3—Shielding—Metal structures can shield RFID tags and impair detection. RFID tags must be located at the apex of any completely metal survey marker to achieve omni directional detection.

8.7—Characteristics of the transponder that may affect the response time will include the minimum input power level for activation, the inherent delay of the transponder circuitry, the alert signal power level, and the effect of temperature, humidity, RF interference and other environmental conditions on the transponder. Characteristics of the portable components of the system that affect the response time include the interrogatory signal power level of the RF interrogator 50, the alert signal power level of the transponder 20, the detection threshold of the RF interrogator, and the gain of the antenna 60.

8.8—Because the transponder is preferably a passive transponder, the lower the input energy required by it to generate an alert signal, the farther the detection range it will have. Therefore, it is desirable that the transponder operate at frequencies that are less susceptible to environmental interference and thus require less power to achieve a given range. This frequency is preferably between 800 MHz and 2.45 GHz, more preferably about 915 MHz. The FCC has set aside a band of frequencies from 902-928 MHz for various purposes. The 915 MHz system according to the present invention falls into the spread-spectrurn application defined in Part 15 of the FCC regulations.

8.9—The portable RF interrogator generates an interrogatory signal that is transmitted via at least one antenna in the direction of travel. This signal activates the transponder, and therefore is of appropriate frequency and power to activate a transponder within the desired detection range. The appropriate frequency is preferably between about 800 MHz and 2.45 GHz; more.preferably about 915 MHz.

8.10—Among the hardware available in the RFID industry today the most appropriate technologies for this application use 915 MHz as the operating frequency.

8.11—The antenna can be a single antenna or multiple antennae. In the case of use of a single antenna, it can be an omni directional antenna, unidirectional antenna, or a directional antenna, such as a dipole antenna or yagi antenna, for increased directionality and range.

8.12—Multiple antennae can be used to increase the directionality and/or range of the system. For example, a phased antenna array can be used. These directional and/or ranging antennae can enhance the ability of the operator to locate utility survey markers.

8.13—An alert signal coming from the transponder is received by the antenna, routed through the RF interrogator, and then transmitted to the control head. Referring now to FIG. 1 and FIG. 2; in the controller 70, the signal is received by a microprocessor 80 that processes the signal and generates the appropriate output to the user interface 72. The outputs generated may include a sensory alarm to alert the user to the presence of a transponder within the detectable range of the system. The sensory alarms may be visual, auditory, or vibratory alarm, and combinations thereof. For example, in situations where there is a high level of background noise, an audible alarm 82 alone may be insufficient to ensure alerting of the operator, and therefore other alarms, such as a flashing red light 76, may be installed in the user interface. The outputs may further include the RFID encoded data previously described, such as unique identifier, specific and/or relative location, description of the tagged survey marker, and the like, displayed in an LCD or similar display screen 78. These outputs can be generated by information transmitted from the transponder, or can be information that is stored in the control head and pre-linked to the unique identifier transmitted by the transponder. In systems where the transponder transmits the specific location of the transponder, and this location can be linked to a survey marker, no reprogramming of the transponder is necessary prior to affixing the transponder to a survey marker. Information about the survey marker most closely associated geographically with the GPS location of the transponder will be displayed on the control head when the transponder alert signal is received. In cases where the GPS location of the transponder can be either transmitted by the transponder or calculated by the microprocessor as described, and the machine is equipped with a GPS system, the direction and distance of the transponder from the receiver can be determined and displayed on the display screen 78.

8.14—In systems using multiple antennae, the direction of the transponder in relation to the receiver can be more accurately determined. For example, multiple, divergent yagi antennae can be arrayed to allow the differentiation of the alert signal into sectors; for example, into three sectors such as dead ahead, proximal left side, and proximal right side. This directional information can then be displayed via the display screen 78 or via other appropriate means.

8.15—The control head also may include basic functions and indicators such as a power switch/power indicator 74, a test switch 84 to allow the operator to perform a system confidence test, and a reset switch 86 that allows the operator to clear alerts manually.

8.16—In a preferred embodiment according to the present invention, the system has an intended read-range of approximately 10 meters. In this embodiment, the interrogator and antenna configuration transmit proprietary patterns of RF energy designed to excite a passive tuned transponder circuit contained in packaged tags attached to an survey marker or alternately integral to the survey marker casing. The placement of the antenna or antennae is such that the radiation pattern extends forward of the portable transceiver and an appropriate alert would be given to the equipment operator warning him/her of the survey marker's close proximity. The transmitter is capable of operating continuously as the survey operation is carried out. Detection and alerts are all handled automatically. Once a tagged survey marker is detected it can be located and more clearly identified with ribbon or other material. If, for example, a fence building crew is scheduled to build a fence, they can subsequently reference the boundary marker more readily after it has been clearly marked with fluorescent ribbon. Once the survey marker has been visually located, the operator resets the alert, thus turning off the lamp and tone. The system is capable of ignoring replies from the alerting tag until the replies stop as a result of the transceiver moving away from the survey marker.

8.17—The RF transponder detection system can also be connected via wireless technologies to separate databases in a remote location, e.g. an office, far from the immediate area in order to provide additional information to the operator in the field.

### 9. OPERATION OF THE INVENTION

9.1—A method for detecting and locating survey markers includes tagging survey markers with preprogrammed passive RFID transponders is described. The transponders may be programmed during manufacturing or at later times, including up to installation. These RFID tags may be preprogrammed with a simple presence signal or with more detailed information. After the survey markers have been tagged, they can be located during subsequent property surveys with the RF transponder detection system. When a tuned transponder comes in the detection range of the detection system, the RF transponder detection system alerts the operator to the presence of the tuned transponder. The operator then attempts to locate the tagged survey marker. If the survey marker is not readily located, the operator sweeps the area until the survey marker is located, based upon the system information indicating the location of a survey marker within a predetermined distance or area. Upon location of the survey marker, the operator manually clears vegetation around the survey marker, and supplements the marker with fluorescent ribbon. Upon locating the survey marker, the operator can reset the alert signal, stopping the alert for the detected survey marker.

### 10. ALTERNATIVE EMBODIMENTS

10.1—The RFID tags may be designed to include a variety of attachment methods, including adhesive methods, clips, rings, hook and loop fasteners, rivets, screws, nails, and various other methods of attachment to existing survey markers. Alternatively, the RFID tags can be integrated into various types of survey markers, for those applications where new property boundaries need to be surveyed and marked. It is anticipated that there will be a market for both embodiments described above. All of the various RFID tags designs will be rugged enough to withstand exposure to outdoor weather conditions.

10.2—Certain modifications and improvements will occur to those skilled in the art upon a reading of the foregoing description. By way of example, the user interface can be expanded to show area maps based on a database of known survey marker locations. The map is capable of automatically reregistering itself each time a known RFID tagged survey marker is encountered. Another example is the connection of the reader via wireless technologies to remote databases in offices far from the field in order to provide additional information to the reader in the field. Integrating the system with GPS or Differential GPS (DGPS) for automatic initialization of newly installed tags is an improvement that can facilitate installation. Another example is integration of the tag into the body of the survey marker itself, thereby preventing theft and vandalism.

10.3—All modifications and improvements have been deleted herein for the sake of conciseness and readability but are properly within the scope of the stated claims.

We claim:

1. A method for detecting and locating property boundary survey markers, including:
tagging said survey markers with preprogrammed passive RFID transponders;
operating a handheld or portable RF transceiver;
detecting a tagged survey marker;
sounding an alert when a tagged survey marker is detected;
locating the tagged survey marker;
clearing the tagged survey marker of visual obstructions; and
improving the process of locating established property boundaries.

2. The method according to claim 1, further including:
the step of programming the RFID transponders at the time of installation.

3. A boundary marker with a programmable weatherproof RFID tag incorporated into said boundary marker.

4. A programmable weatherproof RFID tag incorporating a method of attachment enabling permanent attachment of said RFID tag to various types of boundary markers.

5. An improvement to the utility design of various types of boundary markers incorporating the provision of a flat surface of sufficient area to accommodate the attachment of a weatherproof RFID tag by a bonding means or other suitable means of enjoinment.

6. An improvement to the utility design of various types of boundary markers incorporating the provision of a loop or ring to accommodate the attachment of a weatherproof RFID tag.

7. A weatherproof RFID tag designed to include method of attachment, said method of attachment being an adhesive method, a clip, a ring, hook and loop fasteners, rivets, screws, nails, or various other methods of attachment to either new or existing survey markers.
